(19) United States
(12) Patent Application Publication
(10) Pub. No.: US 2026/0237663 A1
(43) Pub. Date: Aug. 13, 2026

(54) SECONDARY BATTERY

(71) Applicant: DENSO CORPORATION, Kariya-city (JP)

(72) Inventors: Yuta SHIMONISHI, Kariya-city (JP); Shuhei YOSHIDA, Kariya-city (JP); Yuta MASUO, Kariya-city (JP)

(21) Appl. No.: 19/633,341

(22) Filed: Mar. 30, 2026

Related U.S. Application Data
(63) Continuation of application No. PCT/JP2025/022090, filed on Jun. 19, 2025.

(30) Foreign Application Priority Data
Oct. 31, 2024 (JP) 2024-192060

(51) Int. Cl. H01M 4/58; H01M 4/02; H01M 4/36; H01M 4/38; H01M 10/0525; H01M 10/0568

(52) U.S. Cl. CPC H01M 4/5825; H01M 4/364; H01M 4/386; H01M 10/0525; H01M 10/0568; H01M 2004/021; H01M 2004/027; H01M 2004/028

(57) ABSTRACT

A second battery includes a positive electrode layer, a negative electrode layer, and an electrolyte layer to conduct lithium ion between the positive electrode layer and the negative electrode layer. The positive electrode layer is provided with a positive electrode active material containing Mn in its composition and an oxide-based ion conductor having lithium ion conductivity. The electrolyte layer contains a fluorine-containing lithium salt that contains fluorine atoms and a solvent to dissolve the fluorine-containing lithium salt. The oxide-based ion conductor is a dielectric material capable of facilitating dissociation of lithium ion from the fluorine-containing lithium salt.

### CROSS REFERENCE TO RELATED APPLICATION

The present application is a continuation application of International Patent Application No. PCT/JP2025/022090 filed on Jun. 19, 2025, which designated the U.S. and claims the benefit of priority from Japanese Patent Application No. 2024-192060 filed on Oct. 31, 2024. The entire disclosures of all of the above applications are incorporated herein by reference.

### TECHNICAL FIELD

The present disclosure relates to a secondary battery.

### BACKGROUND

In recent years, in order to achieve higher energy density, lower costs, and higher safety in lithium-ion batteries, a mixed material is provided by mixing a graphite negative electrode material with a silicon-based negative electrode material. Further, a mixed material is provided by mixing a ternary positive electrode material with a lithium manganese Ferro phosphate (LMFP) positive electrode material.

### SUMMARY

According to one aspect of the present disclosure, a secondary battery includes a positive electrode layer, a negative electrode layer, and an electrolyte layer to conduct lithium ion between the positive electrode layer and the negative electrode layer. The positive electrode layer is provided with a positive electrode active material containing Mn and an oxide-based ion conductor having lithium ion conductivity. The electrolyte layer includes a fluorine-containing lithium salt that contains fluorine atoms and a solvent to dissolve the fluorine-containing lithium salt. The oxide-based ion conductor is a dielectric material to facilitate dissociation of lithium ion from the fluorine-containing lithium salt. The oxide-based ion conductor may contain an oxyfluoride.

### BRIEF DESCRIPTION OF DRAWINGS

FIG. 1 is a cross-sectional view showing a structure of a secondary battery according to an embodiment of the present disclosure.

FIG. 2 is a perspective view showing a state in which components of a secondary battery are separated.

FIG. 3 is a conceptual diagram showing a configuration of a positive electrode active material and an oxide-based ion conductor.

FIG. 4 is a conceptual diagram showing a configuration of a positive electrode active material and an oxide-based ion conductor.

FIG. 5 is a conceptual diagram showing a configuration of a positive electrode active material and an oxide-based ion conductor.

FIG. 6 is a diagram showing a crystal structure of a pyrochlore-type oxide.

FIG. 7 is a diagram showing a manufacturing process of a pyrochlore-type oxide.

FIG. 8 is a table showing initial resistance and durability of secondary battery in Examples and Comparative examples.

### DETAILED DESCRIPTION

In recent years, in order to achieve higher energy density, lower costs, and higher safety in lithium-ion batteries, a mixed material is provided by mixing a graphite negative electrode material with a silicon-based negative electrode material. Further, a mixed material is provided by mixing a ternary positive electrode material with a lithium manganese Ferro phosphate (LMFP) positive electrode material. These mixed materials may contain an amount of water, such as water adsorbed on the surface of the material and water of crystallization that has entered the crystals of the material.

When such a mixed material containing water is used in the production of a battery, if the water cannot be sufficiently removed during the battery production process, a small amount of water will remain inside the battery. When lithium hexafluorophosphate (LiPF₆), which is a fluorine-containing lithium salt, is used as the electrolyte in such a battery, PF₅ generated from LiPF₆ reacts with moisture to easily generate hydrogen fluoride (HF). The generation of hydrogen fluoride accelerates deterioration such as destruction of the SEI (Solid Electrolyte Interface) coating, which is an inactive coating containing metal at the negative electrode, and metal elution from the positive electrode active material, thereby reducing the durability of the secondary battery.

An additive may be added to the electrolyte to trap PF₅ generated from LiPF₆, thereby restricting the generation of hydrogen fluoride.

However, an additive is added to the electrolyte, which increases the resistance of the electrolyte and reduces the output of the secondary battery.

The present disclosure provides a secondary battery to restrict deterioration caused by the generation of hydrogen fluoride from a fluorine-containing lithium salt while suppressing a decrease in output in the secondary battery using a fluorine-containing lithium salt.

According to one aspect of the present disclosure, a positive electrode layer, a negative electrode layer, and an electrolyte layer are provided to conduct lithium ion between the positive electrode layer and the negative electrode layer. The positive electrode layer is provided with a positive electrode active material containing Mn in its composition and an oxide-based ion conductor having lithium ion conductivity. The electrolyte layer includes a fluorine-containing lithium salt that contains fluorine atoms and a solvent to dissolve the fluorine-containing lithium salt. The oxide-based ion conductor is a dielectric material to promote the dissociation of lithium ions from the fluorine-containing lithium salt.

This allows the dielectric effect of the oxide-based ion conductor to prioritize the reaction of dissociating lithium ions from the fluorine-containing lithium salt, thereby suppressing the generation of hydrogen fluoride from the fluorine-containing lithium salt. The oxide-based ion conductor has lithium ion conductivity, and can suppress a decrease in the resistance of the secondary battery while suppressing deterioration of the secondary battery due to the generation of hydrogen fluoride from the fluorine-containing lithium salt.

The embodiments of the present disclosure will be described below with reference to the drawings. Unless otherwise specified, the particle diameter in this embodiment is the particle median diameter D50. The particle median diameter D50 means the volume-based particle diameter at which the volume of particles integrating from the smaller particle diameter in the particle diameter distribution reaches 50% of the total particle volume. In other words, the particle median diameter D50 means a diameter of the particle corresponding to the median value of the particle diameter distribution.

A secondary battery 10 of this embodiment is a lithium-ion battery in which lithium ions conduct as conductive ions.

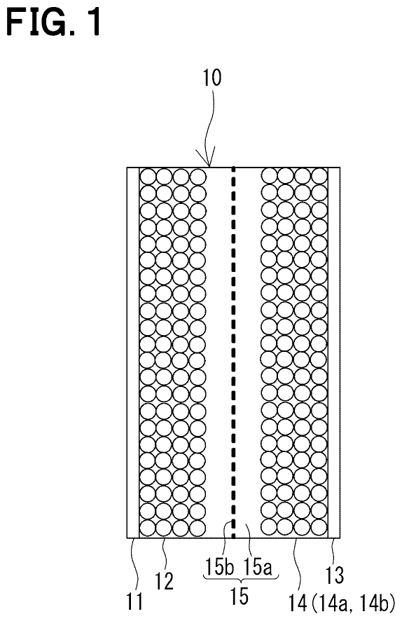

As shown in FIG. 1, the secondary battery 10 includes, as its components, a negative electrode current collector 11, a negative electrode layer 12, a positive electrode current collector 13, a positive electrode layer 14, and an electrolyte layer 15. The negative electrode current collector 11, the negative electrode layer 12, the positive electrode current collector 13, the positive electrode layer 14, and the electrolyte layer 15 are stacked in a predetermined stacking direction. In FIG. 1, the left-right direction corresponds to the stacking direction in the secondary battery 10.

The electrolyte layer 15 includes an electrolyte solution 15a and an insulating layer 15b. The electrolyte solution 15a is present from the negative electrode layer 12 to the positive electrode layer 14, and permeates into the negative electrode layer 12 and the positive electrode layer 14. The electrolyte layer 15 may be made of liquid, or may contain a solid electrolyte in addition to liquid. The secondary battery 10 may contain a small amount of water (H₂O) in the electrolyte solution 15a. The amount of water is preferably small relative to the total amount of the electrolyte solution 15a.

The electrolyte layer 15 is interposed between electrodes 12, 14 of the negative electrode layer 12 and the positive electrode layer 14. The negative electrode layer 12 and the electrolyte layer 15 are in contact with each other. The positive electrode layer 14 and the electrolyte layer 15 are in contact with each other. The negative electrode layer 12 and the positive electrode layer 14 are bonded to each other via the electrolyte layer 15. The secondary battery 10 is charged and discharged by lithium ions moving between the negative electrode layer 12 and the positive electrode layer 14 via the electrolyte layer 15.

The secondary battery 10 of this embodiment is configured as a high-power battery in which the reaction area of the electrodes 12, 14 is large relative to the battery capacity. In a high-power battery, the ratio of the area A (mm²) of the opposing surface between the negative electrode layer 12 and the positive electrode layer 14 to the battery capacity B (mAh) of the secondary battery 10 is large.

The negative electrode layer 12 has an opposing surface facing the positive electrode layer 14 with the electrolyte layer 15 interposed therebetween. The positive electrode layer 14 has an opposing surface facing the negative electrode layer 12 with the electrolyte layer interposed therebetween. Hereinafter, the opposing surfaces of the negative electrode layer 12 and the positive electrode layer 14 will be referred to as electrode opposing surface, and the area of the opposing surface of the negative electrode layer 12 and the positive electrode layer 14 will also be referred to as electrode opposing area.

As will be described later, in this embodiment, the oxide-based ion conductor 14b is provided in the positive electrode layer 14 to suppress the generation of hydrogen fluoride and to suppress the deterioration of the secondary battery 10.

The larger the ratio A/B of the electrode opposing area A (mm²) to the battery capacity B (mAh), the greater the deterioration of the secondary battery 10 when hydrogen fluoride is generated. However, by providing the oxide-based ion conductor 14b in the positive electrode layer 14, the effect of suppressing deterioration of the secondary battery 10 is enhanced. The effect of the oxide-based ion conductor 14b in suppressing deterioration of the secondary battery 10 is high when the ratio A/B is 10 (mm²/mAh) or more, is even higher when the ratio A/B is 30 (mm²/mAh) or more, and is even higher when the ratio A/B is 40 (mm²/mAh) or more.

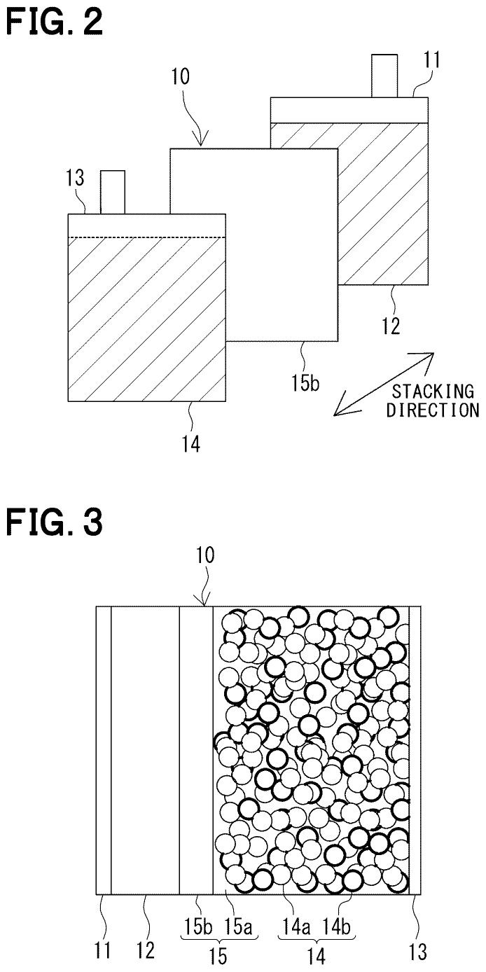

As shown in FIG. 2, the negative electrode layer 12 and the positive electrode layer 14 are plate-shaped and face each other with the insulating layer 15b of the electrolyte layer 15 interposed therebetween. That is, the opposing surface of the negative electrode layer 12 faces the insulating layer 15b of the electrolyte layer 15, and the opposing surface of the positive electrode layer 14 faces the insulating layer 15b of the electrolyte layer 15. When viewed in the stacking direction of the negative electrode layer 12 and the positive electrode layer 14, the negative electrode layer 12 and the positive electrode layer 14 overlap each other. In other words, there is a portion where the projection surface of the negative electrode layer 12 in the stacking direction and the projection surface of the positive electrode layer 14 in the stacking direction overlap. The electrode opposing area is the area where the negative electrode layer 12 and the positive electrode layer 14 overlap each other. In FIG. 2, the area indicated by the diagonal lines sloping upward to the right is the electrode opposing area.

When the area of the negative electrode layer 12 and the area of the positive electrode layer 14 are different, the electrode opposing area is defined as the area of the portion where the negative electrode layer 12 and the positive electrode layer 14 overlap.

The electrolyte solution 15a has lithium ion conductivity and conducts ions between the negative electrode layer 12 and the positive electrode layer 14. The electrolyte solution 15a contains electrolyte made of a lithium salt and a solvent capable of dissolving the lithium salt.

In this embodiment, a fluorine-containing lithium salt containing fluorine atoms is used as the lithium salt of the electrolyte solution 15a. Examples of the fluorine-containing lithium salt that can be used include LiPF₆, LiFSI (lithium bis(fluorosulfonyl)imide), and LiTFSI (lithium bis(trifluoromethanesulfonyl)imide). The fluorine-containing lithium salt may be used alone or in combination. In this embodiment, LiPF₆ is used as the fluorine-containing lithium salt.

The fluorine-containing lithium salt is easily dissociated into LiF and fluorine compounds by thermal decomposition or the like. The fluorine compound dissociated from the fluorine-containing lithium salt is a substance that can react with H₂O to generate hydrogen fluoride (HF). Therefore, when a fluorine compound dissociates from the fluorine-containing lithium salt, the fluorine compound may react with the moisture contained in the secondary battery 10 to generate hydrogen fluoride (HF). The generation of hydrogen fluoride leads to deterioration of the secondary battery 10.

LiPF₆ used as the fluorine-containing lithium salt in this embodiment is prone to undergo a dissociation reaction of PF₅, that is, “LiPF₆→LiF+PF₅” by thermal decomposition, and is prone to undergo a reaction of PF₅ reacting with moisture to produce hydrogen fluoride, that is, “PF₅+H₂O→2HF+POF₃.” In a high-power battery with a large reaction area such as the secondary battery 10 of this embodiment, the effects of hydrogen fluoride generation tend to be significant.

The solvent for the electrolyte solution 15a may be an organic electrolytic solution, an ionic liquid, a gel polymer, or the like. As the organic electrolyte, ethylene carbonate, diethyl carbonate, propylene carbonate, or the like can be used. These solvents may be used alone or in combination.

The insulating layer 15b is disposed between the negative electrode layer 12 and the positive electrode layer 14 to prevent the opposing surface of the negative electrode layer 12 from coming into direct physical contact with the opposing surface of the positive electrode layer 14. The insulating layer 15b is an insulating ion-permeable membrane that prevents physical contact between the negative electrode layer 12 and the positive electrode layer 14 to prevent electrical short circuits, and also allows ions to pass through.

In this embodiment, a porous separator is used as the insulating layer 15b. The separator may be made of polypropylene, polyethylene, or nonwoven fabric. The surface of the separator may be coated with a solid electrolyte. The insulating layer 15b may be a polymer sheet or a solid electrolyte sheet. The solid electrolyte sheet is a free-standing membrane.

The negative electrode current collector 11 and the positive electrode current collector 13 can be made of any material used as a current collector for lithium-ion battery. In this embodiment, Cu is used as the negative electrode current collector 11, and Al is used as the positive electrode current collector 13.

A negative electrode material of the negative electrode layer 12 can be any material used as a negative electrode active material for lithium-ion battery, such as a carbon-based negative electrode material, an oxide-based negative electrode material, or a metal-based negative electrode material. These negative electrode materials may be used alone or in combination.

As the carbon-based negative electrode material, for example, natural graphite, artificial graphite, and hard carbon can be used. As the oxide-based negative electrode material, for example, Li₄Ti₅O₁₂, TiO₂(B), or TiNb₂O₇ can be used. As the metal-based negative electrode material, for example, a silicon-based negative electrode material or lithium metal can be used.

In this embodiment, graphite and a silicon-based negative electrode material are used as the negative electrode active material. The silicon-based negative electrode material is a negative electrode material that contains Si. Graphite can be used alone as the negative electrode active material, or a mixed material in which graphite is mixed with a silicon-based negative electrode material can be used as the negative electrode active material.

The silicon-based negative electrode materials containing Si have a high moisture adsorption capacity and contain a large amount of moisture carried over. Therefore, in case where the negative electrode active material contains a silicon-based negative electrode material, when PF₅ dissociates from LiPF₆, which is a fluorine-containing lithium salt, PF₅ reacts with moisture to easily generate hydrogen fluoride.

The silicon-based negative electrode materials include Si, SiO, Si/C composite materials, and the like. In this embodiment, a silicon compound containing silicon, such as SiO or Si/C, is used as the silicon-based negative electrode material. The smaller the particle size of the Si compound, the greater the amount of moisture carried over. When the particle size of the Si compound is 5 μm or less, the amount of water carried over becomes particularly large, making it easier to generate hydrogen fluoride from the fluorine-containing lithium salt.

The particle size of the Si compound is the particle median diameter D50. The particle median diameter D50 means the volume-based particle diameter at which the volume of particles integrating from the smaller particle diameter in the particle diameter distribution reaches 50% of the total particle volume. In other words, the particle median diameter D50 means a diameter of the particle corresponding to the median value of the particle diameter distribution.

In addition, an SEI coating is formed on the interface of the negative electrode layer 12 with the electrolyte solution 15a. The SEI coating has the role of inserting and desorbing lithium ions, but if hydrogen fluoride is generated from the fluorine-containing lithium salt, the SEI coating may be destroyed, causing deterioration of the secondary battery 10.

The negative electrode layer 12 may contain a conductive additive, a binder, and a polymer. The conductive additive may be, for example, a carbon material such as carbon black. As the binder, for example, a water-based binder such as a mixture of SBR (styrene butadiene rubber) and CMC (carboxymethyl cellulose) can be used. Furthermore, since polyacrylic binders using polyacrylic acid are deliquescent, they bring in a large amount of moisture, which makes it easier to generate hydrogen fluoride from the fluorine-containing lithium salt.

Furthermore, the negative electrode layer 12 may contain a solid electrolyte. When the negative electrode layer 12 contains a solid electrolyte, the solid electrolyte may be mixed with the negative electrode material, or the surface of the negative electrode material may be coated with the solid electrolyte.

The positive electrode layer 14 releases lithium ions during the charging of the secondary battery 10 and accepts lithium ions during the discharging of the secondary battery 10. The positive electrode layer 14 includes a positive electrode active material 14a as a positive electrode material, and an oxide-based ion conductor 14b having ionic conductivity. The oxide-based ion conductor 14b is an oxide-based solid electrolyte having lithium ion conductivity, and can suppress the generation of hydrogen fluoride from the fluorine-containing lithium salt.

The positive electrode layer 14 may contain a conductive additive, a binder, and a polymer. The conductive additive may be, for example, a carbon material such as carbon black. As the binder, for example, polyvinylidene fluoride (PVdF) can be used. The positive electrode layer 14 may further include a solid electrolyte. When the positive electrode layer 14 contains a solid electrolyte, the solid electrolyte may be mixed with the positive electrode active material 14a, or the surface of the positive electrode active material 14a may be coated with the solid electrolyte.

In the positive electrode layer 14, the positive electrode active material 14a and the oxide-based ion conductor 14b can be provided in any manner. In the positive electrode layer 14, it is sufficient that the oxide-based ion conductor 14b is in direct contact with the electrolyte solution 15a. In the examples shown in FIGS. 3 to 5, the positive electrode active material 14a and the oxide-based ion conductor 14b are different in form in the positive electrode layer 14.

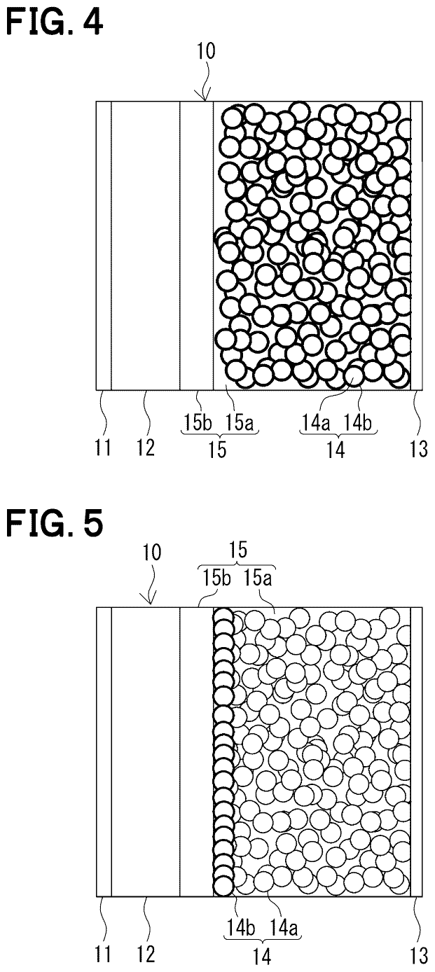

FIG. 3 shows an example in which the positive electrode layer 14 has a random structure in which particles of the positive electrode active material 14a and particles of the oxide-based ion conductor 14b are randomly mixed. FIG. 4 shows an example of a layered structure in which the outer surface of the particle of the positive electrode active material 14a is covered with the oxide-based ion conductor 14b in the positive electrode layer 14.

FIG. 5 shows an example in which the oxide-based ion conductor 14b is provided between the separator of the insulating layer 15b and the positive electrode active material 14a. In FIG. 5, the oxide-based ion conductor 14b can be applied to the side surface of the separator adjacent to the positive electrode or the side surface of the positive electrode active material 14a adjacent to the separator.

The positive electrode active material 14a used in this embodiment contains Mn in its composition. When hydrogen fluoride is generated from the fluorine-containing lithium salt, metal elements may be eluted from the crystal structure of the positive electrode active material 14a, possibly causing deterioration of the positive electrode active material 14a. Among the metal elements constituting the positive electrode active material 14a, Mn is easily eluted by hydrogen fluoride, and the positive electrode active material 14a is easily deteriorated.

As the positive electrode active material 14a containing Mn, for example, a layered rock salt type active material, an olivine type active material, a spinel type active material, or an acid halide type active material can be used.

As the layered rock salt type active material containing Mn, for example, a ternary positive electrode material such as LiNiₓCo_{y}Mn_{z}O₂ (NCM) can be used. As the olivine type active material containing Mn, for example, LiMn₁₋ₓFeₓPO₄ (LMFP) and LiMnPO₄ (LMP) can be used. Examples of spinel active materials that can be used include LiMn₂O₄ (LMO) and LiNi_{0.5}Mn_{1.5}O₄ (LNMO). The LNMO has a high operating potential of about 4.7 V, making it possible to operate the secondary battery 10 at a high potential. On the other hand, when the positive electrode active material 14a having a high operating potential such as LNMO is used, the generation of hydrogen fluoride accelerates the deterioration of the positive electrode active material 14a. As the acid halide type active material containing Mn, for example, Li₂MnO₃₋ₓFx can be used.

In this embodiment, the positive electrode active material 14a is made of a layered rock salt active material NCM and an olivine active material LMFP. NCM can be used alone as the positive electrode active material 14a, or a mixed material of NCM and LMFP can be used as the positive electrode active material 14a. In this embodiment, NCM with a particle diameter of 5 μm and LMFP with a particle diameter of 1 μm are used. The particle diameter of the positive electrode active material 14a is the particle median diameter D50.

The higher the Mn content of LMFP, the more effective it is in suppressing the elution of Mn by suppressing the generation of hydrogen fluoride by the oxide-based ion conductor 14b. In this embodiment, x in the composition formula of LMFP, LiMn₁₋ₓFeₓPO₄, is set to 0.5 or less. That is, LMFP having a higher Mn content than Fe is used.

The oxide-based ion conductor 14b is a dielectric material that can promote dissociation of lithium ions from the fluorine-containing lithium salt contained in the electrolyte solution 15a. The oxide-based ion conductor 14b has a higher dielectric constant than oxides such as Al₂O₃. Electrostatic attraction acts on the lithium ions contained in the fluorine-containing lithium salt, to accelerate the dissociation of the lithium ions from the fluorine-containing lithium salt.

The higher the dielectric constant of the oxide-based ion conductor 14b, the greater the effect of promoting dissociation of lithium ions from the fluorine-containing lithium salt. Therefore, the relative dielectric constant of the oxide-based ion conductor 14b is preferably 90 or more, and more preferably 200 or more.

The oxide-based ion conductor 14b promotes dissociation of lithium ions from the fluorine-containing lithium salt. Therefore, when the fluorine-containing lithium salt is LiPF₆, the reaction “LiPF₆→Li⁺+PF₆₋” in which Lit dissociates from LiPF₆ occurs preferentially over the reaction “LiPF₆→LiF+PF₅” in which PF₅ dissociates from LiPF₆, thereby promoting the reduction of LiPF₆. This makes it difficult for the reaction “LiPF₆→LiF+PF₅” in which PF₅ dissociates from LiPF₆ to occur, and makes it possible to suppress the reaction of PF₅ with moisture to produce hydrogen fluoride.

As the oxide-based ion conductor 14b having a high dielectric constant, for example, a pyrochlore-type oxide, a NASICON-type oxide, or the like can be used. Examples of pyrochlore-type oxides include Li₂₋ₓLa_{(1+x)/3}Nb₂O₆F (i.e., LLNOF) and Li₂₋ₓLa_{(1+x)/3}Ta₂O₆F (i.e., LLTOF). These pyrochlore-type oxides have a defect structure, are oxyfluorides, and are Lewis acidic. As the NASICON type oxide, for example, Li₁₊ₓAlₓTi₂₋ₓ(PO₄)₃ (LATP) can be used. The dielectric constant of LLNOF is higher than that of LATP.

In this embodiment, the pyrochlore-type oxide is used as the oxide-based ion conductor 14b. The pyrochlore-type oxide has high ionic conductivity and can improve the ionic conductivity of the secondary battery 10. Furthermore, pyrochlore-type oxides are materials with high dielectric constants, and are highly effective in promoting the dissociation of lithium ions from fluorine-containing lithium salts. The pyrochlore-type oxide will be described in detail later.

The ratio of the oxide-based ion conductor 14b to the positive electrode active material 14a is not particularly limited. From the viewpoint of achieving a greater resistance reduction and durability improvement effect while simultaneously achieving the energy density of the battery, it is preferable that the proportion x of the oxide-based ion conductor 14b added to the positive electrode active material 14a is, for example, 0 wt %<x≤10 wt %.

The oxide-based ion conductor 14b of this embodiment exhibits electronic conductivity by inserting lithium ions, which are conductive ions, into the crystal structure. When the electrode potential of the oxide-based ion conductor 14b is lowered, the lithium ion insertion/extraction reaction of the oxide-based ion conductor 14b is promoted. In the pyrochlore-type oxide, the electrode potential at which the lithium ion insertion/extraction reaction occurs changes depending on the type of cation B. When Nb is used as the cationic metal represented by B in the composition formula, the pyrochlore-type oxide can enhance the effect of exhibiting electronic conductivity.

The smaller the particle diameter of the oxide-based ion conductor 14b, the larger the specific surface area of the oxide-based ion conductor 14b, and the higher the dielectric effect of the oxide-based ion conductor 14b. This enhances the effect of promoting dissociation of lithium ions from the fluorine-containing lithium salt by the oxide-based ion conductor 14b. For this reason, in this embodiment, the particle diameter of the oxide-based ion conductor 14b is set to be smaller than the particle diameter of the positive electrode active material 14a. In this embodiment, the particle diameter of the positive electrode active material 14a is set to 1 to 5 μm, and the particle diameter of the oxide-based ion conductor 14b is set to 0.1 to 0.5 μm. The particle diameter of the positive electrode active material 14a and the oxide-based ion conductor 14b is the particle median diameter D50.

The pyrochlore-type oxide used as the oxide-based ion conductor 14b of the positive electrode layer 14 will be described.

The pyrochlore-type oxide used in this embodiment has a pyrochlore structure represented by composition formula “Aa_{2-α}Ab_{(1+α)/3}B₂O_{7-β}X_{γ}”. In the composition formula, O represents an oxygen atom, and Aa, Ab, B, and X represent any elements or groups. Aa, Ab, and B are different types of cations, while O and X are different types of anions. Aa is an alkali metal cation. The pyrochlore-type oxide contains multiple cations in its composition, including an alkali metal cation Aa and multiple cations Ab and B different from the alkali metal cation Aa. In other words, the pyrochlore-type oxide contains multiple cations in its composition, including the alkali metal cation Aa.

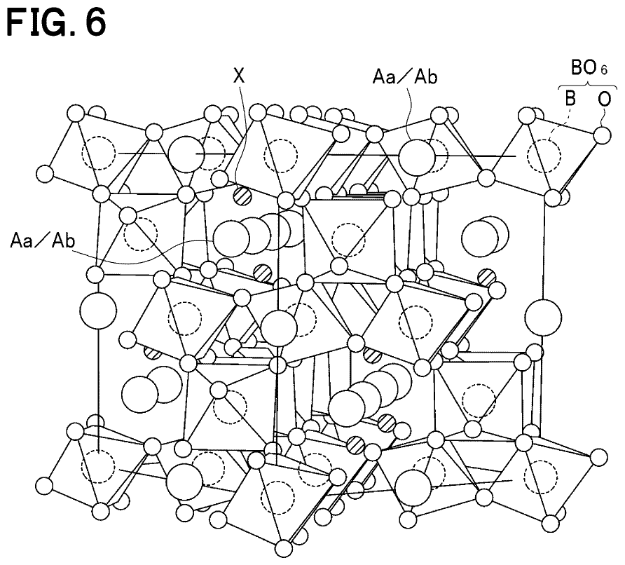

As shown in FIG. 6, the pyrochlore-type oxide has a crystal structure in which a three-dimensional network of octahedra made of BO₆ is formed. BO₆ contains a cation B at the center with O positioned at the vertices, and shares vertices with adjacent BO₆. In the three-dimensional network consisting of BO₆, a hexagonal tunnel structure is formed where cation A and anion X are positioned.

In the composition formula, 0.6<α<2.0, 0<β≤1, and 0<γ≤1 are satisfied. As a changes, the composition ratio of Aa to Ab changes. As β and γ change, the composition ratio of O to X changes.

The cation Aa is an alkali metal cation. As the alkali metal represented by Aa, any one of Li, Na, K, Rb, or Cs can be used. As the cation Aa, Mg or H other than alkali metals may be used. In other words, the cation Aa includes at least one selected from Li, Na, K, Rb, Cs, Mg, and H. In this embodiment, Li is used as Aa. The composition ratio (2−α) of Aa falls within the range of 0<(2−α)<1.4.

The cation Ab includes at least lanthanoid. As the lanthanoid represented by Ab, at least one of La, Ce, Nd, or Sm can be used. In this embodiment, La is used as Ab. The composition ratio (1+α)/3 of Ab falls within the range of 0.53< (1+a)/3<1.

The basic structure of the cation Ab consists of lanthanoid. A portion of the lanthanoid constituting Ab may be substituted with an alkaline earth metal (such as Ca, Mg, or Sr). Regarding the pyrochlore-type oxide of the present embodiment, the lanthanoid is contained in the pyrochlore structure in which 0.6<α≤2.0 and 0<β≤1 in the composition formula. Since defects are generated in the crystal structure, it is considered that the ionic conductivity is improved. In this embodiment, La is used as Ab.

The pyrochlore-type oxide of this embodiment is a composite cation where the cation A in the general pyrochlore structure composition formula “A₂B₂O₇” is a combination of lithium metal and lanthanoid. This is believed to contribute to the improvement of the ionic conductivity of the pyrochlore-type oxide.

The cation B is a metal cation different from Aa and Ab, selected from transition metals or metals from groups 13 to 15. B forms an octahedron surrounded by six O atoms within the crystal. As the transition metal represented by B, a group 4 or group 5 transition metal can be used, and more specifically, at least one of Nb, Ta, Ti, Zr, Hf, or V can be used. Al, Ga, or In can be used as the group 13 element represented by B. As the group 14 element, Ge or Sn can be used. As the group 15 element, Sb or Bi can be used.

The anion X can substitute for the O atom of the pyrochlore structure. The anion X has different electronegativity and polarizability compared to the O atom. As the anion represented by X, at least one of O, F, Cl, Br, I, S, OH, or P can be used. The composition ratio γ of X falls within the range of 0<γ≤1, and at least a part of the O atoms constituting the pyrochlore structure is substituted with X.

The pyrochlore-type oxide of this embodiment has a defect structure that includes lattice defects in the crystal, by substituting a part of the O atoms of the pyrochlore structure with an anion that has different electronegativity and polarizability from the O atom. The pyrochlore-type oxide of this embodiment is believed to have improved ionic conductivity due to the defect structure within the pyrochlore structure.

The pyrochlore-type oxide is preferably a halogen-containing oxide in which a halogen element is used as the anion X. In the pyrochlore-type oxide containing a halogen element, defects are generated in the crystal structure, which facilitates insertion and extraction of Li, and makes it easier for the pyrochlore-type oxide to exhibit electronic conductivity. It is preferable to use F as the anion X. In other words, the pyrochlore-type oxide is preferably an oxyfluoride in which part of O is substituted with F.

In the pyrochlore-type oxide of this embodiment, as the defect structure, a part of Aa and Ab is deficient. The general formula for pyrochlore structure is “A₂B₂O₇”, and the compositional ratio of the cation A is 2. In contrast, in the pyrochlore-type oxide of this embodiment, the compositional ratios of Aa and Ab are “2−α” and “(1+α)/3” respectively and 0.6<α≤2.0 is satisfied. Therefore, the total compositional ratio of Aa and Ab is less than 2. In other words, in the crystal structure of the pyrochlore-type oxide of this embodiment, at least a part of either Aa or Ab is deficient. The compositional ratio corresponding to the deficient portion of Aa and Ab is (2α−1)/3.

Apart from the deviation in compositional ratio, a defect structure can be formed by making the sum of the valences of the cations consisting of Aa, Ab, and B, and the anions consisting of O and X, negative in the compositional formula.

The pyrochlore-type oxide of this embodiment is a composite anion compound in which plural anions, such as O and X, are contained in the pyrochlore structure. Since the anion represented by X is present in the BO₆ octahedron structure, the alkali metal Aa can be positioned in the center of the space between the BO₆ octahedron and the BO₆ octahedron, without moving closer to the BO₆ octahedron. Thus, the pyrochlore-type oxide of this embodiment is considered to have high ionic conductivity when used under an electric field, such as in a battery.

Since α, β, and γ in the compositional formula affect lattice defects and ionic conductivity, it is desirable to set α, β, and γ within an appropriate range. When the values of α, β, and γ are large, the defect concentration in the crystal lattice increases. However, if the values of α, β, and γ exceed a certain amount, the concentration of the alkali metal represented by Aa decreases, leading to a reduction in ionic conductivity. Thus, it is desirable to control a within the range of 0.6<α≤2.0, β within the range of 0<β≤1, and γ within the range of 0<γ≤1.

An example of the pyrochlore-type oxide is represented by “Li_{1.25}La_{0.58}Nb₂O₆F (LLNOF).” In LLNOF, Li is used as cation Aa, La as cation Ab, Nb or Ta as cation B, and F as anion X, with α=0.75, β=1, and γ=1.

The pyrochlore-type oxide of this embodiment achieves an ionic conductivity of 1×10⁻³ S/cm or higher. The pyrochlore-type oxide of this embodiment has a significantly higher ionic conductivity than other oxide-based solid electrolytes such as garnet-type oxides.

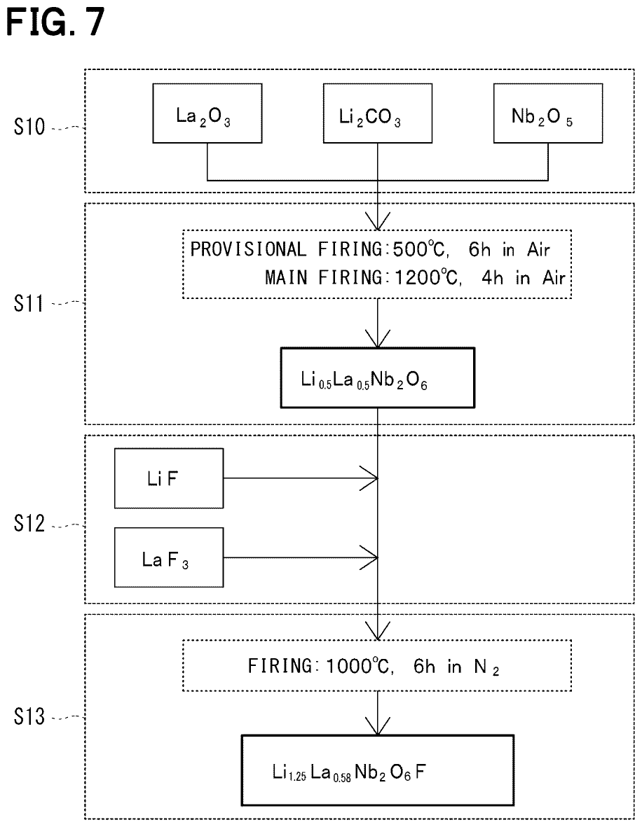

FIG. 7 illustrates the manufacturing method of the pyrochlore-type oxide according to this embodiment. In the method for producing the pyrochlore-type oxide, a first mixing step S10, a first firing step S11, a second mixing step S12, and a second firing step S13 are carried out in this order.

First, a lanthanum source, a lithium source, and a niobium source are prepared as raw materials of the pyrochlore-type oxide, and the first mixing step S10 of mixing the raw materials is performed. As the lanthanum source, the lithium source, and the niobium source, metal oxides, metal carbonates, or the like can be used. In the present embodiment, La₂O₃ is used as the lanthanum source, Li₂CO₃ is used as the lithium source, and Nb₂O₅ is used as the niobium source. In the first mixing step, La₂O₃, Li₂CO₃, and Nb₂O₅ are mixed at a predetermined ratio.

Next, the first firing step S11 is performed in which the mixture prepared in the first mixing step is fired. In the first firing step S11, a two-stage firing step is performed. As the first stage, a provisional firing is performed by heating the mixture in air at 500° C. for 6 hours. The provisional firing removes moisture and other substances from the mixture, thereby enhancing its reactivity. Subsequent to the provisional firing, a main firing in which the mixture is heated in air at 1200° C. for 4 hours is performed. Accordingly, Li_{0.5}La_{0.5}Nb₂O₆ which is a precursor of a target product is obtained.

Next, a fluorine source is prepared as a raw material, and mixed with the precursor in the second mixing step S12. A metal fluoride may be used as the fluorine source. In this embodiment, LiF and LaF₃ are used as the fluorine source. LiF serves as both the fluorine source and the lithium source, while LaF₃ serves as both the fluorine source and the lanthanum source. In the second mixing step, LiF and LaF₃ are mixed with the precursor at a predetermined ratio.

Next, the second firing step S13 is performed in which the mixture of the precursor, LiF, and LaF₃ is sintered. In the second firing step S13, the mixture of the precursor, LiF, and LaF₃ is heated and sintered at 1000° C. for 6 hours in a nitrogen atmosphere. In the second firing step S13, to reduce compositional deviation due to the volatilization of Li and F elements, sintering may be performed in a sealed state or in a state covered with mother powder.

By cooling the product of the second firing step, a pyrochlore-type oxide represented by the compositional formula “Li_{1.25}La_{0.58}Nb₂O₆F (LLNOF)” is obtained. The obtained pyrochlore-type oxide is in particulate form.

A pyrochlore solid electrolyte represented by the composition formula “Li_{2-α}La_{(1+α)/3}Nb₂O_{7-β}F_{γ}” can be obtained by changing the mixing ratio of La₂O₃, Li₂CO₃, Nb₂O₅, LiF, and LaF₃ in the above production process. The values of α, β, and γ in the composition formula can be adjusted by changing the mixing ratio of La₂O₃, Li₂CO₃, Nb₂O₅, LiF, and LaF₃. A portion of the material sublimates during the firing step. Thus, the values of α, β, and γ can also be adjusted by changing the firing conditions, the atmosphere in the firing furnace, and the size of the firing furnace in the first and second firing steps.

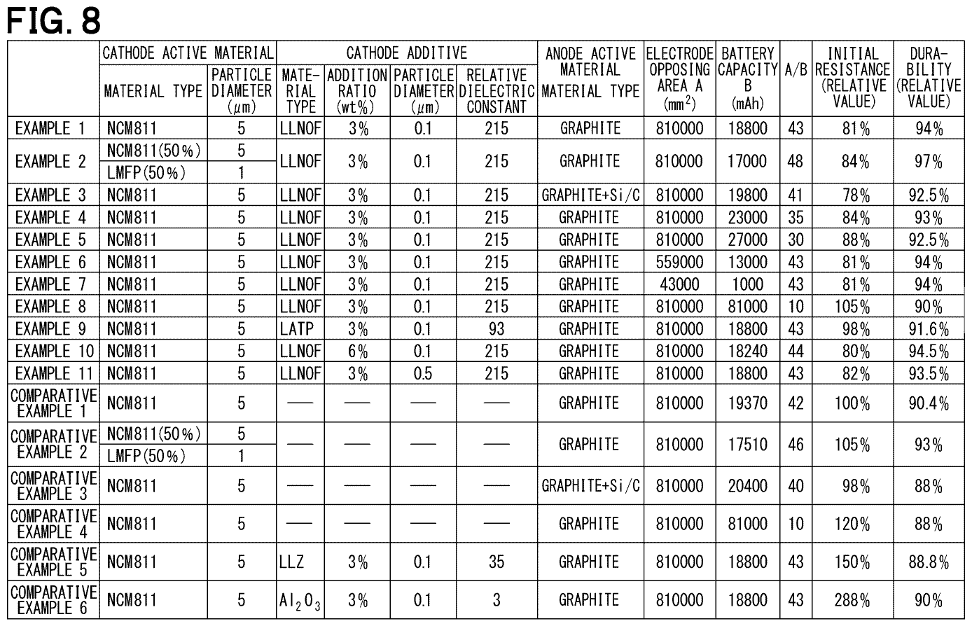

Next, the initial resistance and the durability of the secondary battery 10 will be described using Examples and Comparative examples. FIG. 8 shows the initial resistance and the durability of the secondary battery 10 when changing the type of positive electrode active material 14a, the type or presence of positive electrode additive, the type of negative electrode active material, and the ratio A/B of the electrode opposing area A to the battery capacity B.

The secondary battery 10 has the following common configuration among Examples 1 to 11 and Comparative examples 1 to 6 shown in FIG. 8. The negative electrode layer 12 contains a conductive additive and a binder made of CMC and SBR. The positive electrode layer 14 uses a conductive additive and a binder made of PVdF. The electrolyte layer 15 uses the electrolyte solution 15a in which a fluorine-containing lithium salt made of LiPF₆ is dissolved in a solvent in which ethylene carbonate and diethyl carbonate are mixed in a ratio of 1:1. The concentration of LiPF₆ in the electrolyte solution 15a is 1M.

In Examples 1 and 3 to 11 and Comparative examples 1 and 3 to 6, NCM811 (LiNi_{0.8}Co_{0.1}Mn_{0.1}O₂) is used as the positive electrode active material 14a. In Example 2 and Comparative example 2, a mixed material in which NCM811 and LMFP (LiMn_{0.6}Fe_{0.4}PO₄) are mixed in a ratio of 50% each is used as the positive electrode active material. The particle diameter of NCM811 used in Examples 1 to 11 and Comparative examples 1 to 6 is 5 μm. The particle diameter of the LMFP used in Example 2 and Comparative example 2 is 1 μm.

The particle diameter in this embodiment was measured as follows. The particle diameter was measured by dispersing the powder in ethanol and measuring the volume average particle size distribution using a laser diffraction/scattering particle size distribution measuring device, Partica LA-960 manufactured by Horiba Ltd. The particle diameter is the particle median diameter D50, which is the volume-based particle size when the volume of particles is integrated starting from the smaller particle size in the particle size distribution and reaches 50% of the total particle volume.

In Examples 1 to 8, 10, and 11, LLNOF (Li_{1.25}La_{0.58}Nb₂O₆F), which is a pyrochlore-type oxide and is an example of the oxide-based ion conductor 14b, is used as the positive electrode additive. In Example 9, LATP (Li_{1.4}Al_{0.4}Ti_{1.6}(PO₄)₃), which is a NASICON-type oxide, is used. The positive electrode can be produced as follows. The positive electrode active material, the conductive additive, the binder, and the oxide-based ion conductor were mixed, and NMP (N-methylpyrrolidone) was added to prepare a paste. This paste was applied to an Al foil current collector and allowed to dry. Thereafter, the sheet was pressed to a predetermined thickness and cut into a predetermined electrode size to prepare a positive electrode.

In Comparative examples 1 to 4, the oxide-based ion conductor 14b is not provided in the positive electrode layer 14. In Comparative example 5, the positive electrode layer 14 is provided with LLZ (Li7La₃Zr₂O₁₂) as the oxide-based ion conductor 14b. In Comparative example 6, the positive electrode layer 14 is provided with Al₂O₃ as a positive electrode additive.

In Examples 1 to 9 and 11, the proportion of the oxide-based ion conductor 14b added to the positive electrode active material 14a is 3 wt %. In Example 10, the proportion of the oxide-based ion conductor 14b added to the positive electrode active material 14a is 6 wt %.

The particle diameter of the oxide-based ion conductor 14b used in Examples 1 to 10 and Comparative examples 5 and 6 is 0.1 μm. The particle diameter of the oxide-based ion conductor 14b used in Example 11 is 0.5 μm. In Examples 1 to 11 and Comparative examples 5 and 6, the particle diameter of the oxide-based ion conductor 14b is smaller than the particle diameter of the positive electrode active material 14a.

The relative dielectric constant of the oxide-based ion conductor 14b in Examples 1 to 11 and Comparative examples 5 and 6 was calculated by dividing the measured value of the dielectric constant E′ of the oxide-based ion conductor 14b by the dielectric constant so of vacuum. The dielectric constant so of vacuum was set to 8.85×10⁻¹² (F/m). The dielectric constant E′ of the oxide-based ion conductor 14b was measured as follows.

A powder of the oxide-based ion conductor 14b to be measured is pressure-molded to prepare a pellet. The pellets of the oxide-based ion conductor 14b are sintered at high temperature. The sintering conditions vary depending on the type of oxide-based ion conductor 14b. For example, LLNOF was wrapped in Pt foil to prevent fluorine from volatilizing, sealed in an alumina crucible, and heated at 1000° C. for 6 hours. A pellet of the sintered oxide-based ion conductor 14b was taken out, and Ag was sputtered on both sides of the pellet to a thickness of 300 nm to form an electrode, thereby preparing a sample for measuring the dielectric constant.

The measurement sample was placed in a thermostatic chamber at 25° C. and connected to a high-frequency impedance measuring device, and the dielectric constant was measured in voltage mode (PEIS). Impedance measurements were performed at a voltage amplitude of 10 mV and in the frequency range of 100 MHz to 20 Hz.

The dielectric constant ε′ of the measurement sample was calculated using the impedance measurement value according to Formula (1).

$$Formula ( 1 )$$

$${ε}^{′} = \frac{{z}^{′′}}{{C}_{0} ω ( {z}^{′′2} + {z}^{′2} )} \qquad ( 1 )$$

In Formula (1), z′=real part of impedance, z″=imaginary part of impedance, ω=2πf, and f=frequency at the time of impedance measurement, which is specifically 11 MHz. C₀ is the capacitance when there is no measurement sample, and was calculated using Formula (2).

$$Formula ( 2 )$$

$${C}_{0} = {ε}_{0} \frac{S}{d} \qquad ( 2 )$$

In Formula (2), ε₀ is equal to dielectric constant of vacuum, S is equal to area of electrode, and d is equal to electrode spacing.

The measured value of the relative dielectric constant may have an error of up to about ±10%. The measured value of the relative dielectric constant may vary due to variations in the sintered density of the pellets used as the measurement sample when fired, variations in the contact properties of the Ag electrodes on the measurement sample, and the like. Furthermore, pyrochlore-type oxides such as LLNOF tend to lose halogens and lithium during sintering, resulting in variations in the content of these elements, which can lead to large errors when measuring the dielectric constant.

The relative dielectric constant of LLNOF used in Examples 1 to 8, 10 and 11 is 215. The relative dielectric constant of the LATP used in Example 9 is 93. That is, in Examples 1 to 11, the positive electrode layer 14 is provided with the oxide-based ion conductor 14b having a high relative dielectric constant of 90 or more. In particular, in Examples 1 to 8, 10, and 11, the positive electrode layer 14 is provided with the oxide-based ion conductor 14b having a higher dielectric constant of 200 or more.

The relative dielectric constant of the LLZ used in Comparative example 5 is 35. The relative dielectric constant of Al₂O₃ used in Comparative example 6 is 3. That is, in Comparative example 5, the oxide-based ion conductor 14b having a low relative dielectric constant of 35 is used in the positive electrode layer 14. In Comparative example 6, a positive electrode additive having a low relative dielectric constant of less than 10 is provided in the positive electrode layer 14.

In Examples 1, 2, and 4 to 11 and Comparative examples 1, 2, and 4 to 6, graphite was used as the negative electrode active material of the negative electrode layer 12. In Example 3 and Comparative example 3, a mixed material of graphite and an Si/C composite material was used as the negative electrode active material of the negative electrode layer 12.

The negative electrode can be produced as follows. The negative electrode active material, the conductive additive, and the binder were mixed with ion-exchanged water to prepare a paste. This paste was applied to a Cu foil current collector and allowed to dry. Thereafter, the sheet was pressed to a predetermined thickness and cut into a predetermined electrode size to prepare a negative electrode.

The positive electrode and the negative electrode were stacked with a separator interposed therebetween to prepare an electrode assembly. The electrode assembly was housed in a laminate film case, a non-aqueous electrolyte was poured into it, and the case was sealed and welded to prepare a battery.

In Examples 1, 9, and 11, the electrode opposing area A was set to 810,000 mm², the battery capacity B was set to 18,800 mAh, and A/B was set to 43. In Example 2, the electrode opposing area A is 810,000 mm², the battery capacity B is 17,000 mAh, and A/B is 48. In Example 3, the electrode opposing area A is 810,000 mm², the battery capacity B is 19,800 mAh, and A/B is 41.

In Example 4, the electrode opposing area A is 810,000 mm², the battery capacity B is 23,000 mAh, and A/B is 35. In Example 5, the electrode opposing area A is 810,000 mm², the battery capacity B is 27,000 mAh, and A/B is 30. In Example 8, the electrode opposing area A is 810,000 mm², the battery capacity B is 81,000 mAh, and A/B is 10. In Examples 4, 5, and 8, the A/B values are lower than in Example 1.

In Example 6, the electrode opposing area A is 559,000 mm², the battery capacity B is 13,000 mAh, and A/B is 43. In Example 7, the electrode opposing area A is 43,000 mm², the battery capacity B is 1,000 mAh, and A/B is 43. In Examples 6 and 7, the battery size is different from that in Example 1, but the value of A/B is the same as that in Example 1.

In Example 10, the electrode opposing area A is 810,000 mm², the battery capacity B is 18,240 mAh, and A/B is 44.

In Examples 1 to 11, the ratio A/B of the electrode opposing area A to the battery capacity B is within the range of 10 to 48. In Examples 1 to 7 and 9 to 11, the ratio A/B was 30 or more, and the reaction area was larger. In Examples 1 to 3, 6, 7, and 9 to 11, the ratio A/B was 40 or more, and the reaction area was further increased.

In Comparative example 1, the electrode opposing area A is 810,000 mm², the battery capacity B is 19,370 mAh, and A/B is 42. In Comparative example 2, the electrode opposing area A is 810,000 mm², the battery capacity B is 17,510 mAh, and A/B is 46. In Comparative example 3, the electrode opposing area A was set to 810,000 mm², the battery capacity B was set to 20,400 mAh, and A/B was set to 40. In Comparative example 4, the electrode opposing area A was set to 810,000 mm², the battery capacity B was set to 81,000 mAh, and A/B was set to 10. In Comparative examples 1 to 4, the ratio A/B of the electrode opposing area A to the battery capacity B is 10 or more.

In Comparative examples 5 and 6, the electrode opposing area A was set to 810,000 mm², the battery capacity B was set to 18,800 mAh, and A/B was set to 43. In Comparative examples 5 and 6, the battery size is the same as that in Example 1, and the ratio A/B of the electrode opposing area A to the battery capacity B is 30 or more.

Next, the initial resistance of the secondary battery 10 in Examples 1 to 11 and Comparative examples 1 to 6 will be described. The initial resistance is the internal resistance of the secondary battery 10 in its initial state, and the initial resistance shown in FIG. 8 is a relative value with the resistance value of Comparative example 1 taken as 100%.

The resistance of the secondary battery 10 was measured by placing the battery in a thermostatic chamber at 25° C. and charging the battery until the state of charge (SOC) reached 50%, and then measuring the AC impedance. The AC impedance measurement was carried out at an AC amplitude of 10 mV and in the frequency range of 1 MHz to 0.1 Hz. A curve was obtained by fitting the waveform of the circular arc portion in the Nyquist diagram obtained by AC impedance measurement. The value of the x-axis intercept on the low frequency side of the obtained curve was taken as the internal resistance.

As shown in FIG. 8, in Comparative examples 1 to 3 in which the oxide-based ion conductor 14b was not provided in the positive electrode layer 14 and A/B was 40 to 46, the initial resistance of the secondary battery 10 was 98% to 105%. In Comparative example 4 in which the oxide-based ion conductor 14b was not provided in the positive electrode layer 14 and A/B was 10, the initial resistance of the secondary battery 10 was 120%. Comparative examples 1 to 4 are used as reference, and the initial resistance of the secondary battery 10 is compared with Comparative examples 1 to 4, thereby making it possible to evaluate the initial resistance. In other words, provided that the initial resistance of the secondary battery 10 shown in Examples is lower than the initial resistance of the secondary battery 10 shown in the corresponding Comparative example, the secondary battery 10 of Examples can be evaluated as having reduced resistance, i.e., the reduction in output of the secondary battery 10 can be restricted.

In Examples 1 to 7 and 9 to 11 where A/B is 30 to 46, the initial resistance of the secondary battery 10 is 78 to 98%. In Example 8 where A/B is 10, the initial resistance of the secondary battery 10 is 105%. Comparing Examples and Comparative examples with similar A/B ratios, Examples 1 to 7 and 9 to 11 have lower initial resistance than Comparative examples 1 to 3, and Example 8 has lower initial resistance than Comparative example 4. In particular, in Examples 1 to 8, 10, and 11 in which LLNOF was used as the oxide-based ion conductor 14b, a significantly lower initial resistance than in Comparative examples 1 to 4 was obtained.

In Comparative example 5, in which LLZ having a relative dielectric constant of 35 was used as the oxide-based ion conductor 14b, the initial resistance of the secondary battery 10 was a high value of 150%. In Comparative example 6, in which Al₂O₃ having a relative dielectric constant of 3 was used as the positive electrode additive, the initial resistance of the secondary battery 10 was a high value of 288%.

Next, the durability of the secondary battery 10 in Examples 1 to 11 and Comparative examples 1 to 6 will be described. The durability in FIG. 8 is the battery capacity retention rate of the secondary battery 10 after 100 cycle charge/discharge tests have been carried out. The durability shown in FIG. 8 is a relative value with the durability of Comparative example 1 taken as 100%.

In the cycle charge-discharge test, the battery was placed in a thermostatic chamber at 60° C. and subjected to 100 charge-discharge cycles.

The battery was charged at a constant current rate of 0.5 C until the SOC reached 100%, and then constant voltage charging was performed, which was terminated when the charging current reached the equivalent of 0.02 C. The battery was discharged at a constant current rate of 0.5 C until the SOC reached 0%.

As shown in FIG. 8, in Comparative examples 1 to 3 in which the oxide-based ion conductor 14b was not provided in the positive electrode layer 14 and A/B was 40 to 46, the durability of the secondary battery 10 was 88% to 90.4%. In Comparative example 4 in which the oxide-based ion conductor 14b was not provided in the positive electrode layer 14 and A/B was 10, the durability of the secondary battery 10 was 88%. These comparative examples 1 to 4 are used as reference, and the durability of the secondary battery 10 is compared with Comparative examples 1 to 4, thereby making it possible to evaluate the durability.

In Comparative examples 5 and 6, although the ratio A/B of the electrode opposing area A to the battery capacity B is 30 or more, the relative dielectric constant of the oxide-based ion conductor 14b is less than 100. That is, and the durability of the secondary battery 10 is 88.8 to 90%, which is lower than that of Comparative examples 1 to 3.

In Examples 1 to 7 and 9 to 11 where A/B was 30 to 46, the durability of the secondary battery 10 was 91.6 to 97%. In Example 8 where A/B was 10, the durability of the secondary battery 10 was 90%. Comparing Examples and Comparative examples with similar A/B ratios, Examples 1 to 7 and 9 to 11 have higher durability than Comparative example 1, and Example 8 has higher durability than Comparative example 4. In particular, in Examples 1 to 7, 10, and 11 in which LLNOF was used as the oxide-based ion conductor 14b and A/B was 30 or more, the durability of the secondary battery 10 was as high as 92.5 to 97%.

Example 1 and Comparative example 1, Example 2 and Comparative example 2, Example 3 and Comparative example 3, and Example 8 and Comparative example 4 have similar battery configurations except for the presence or absence of the oxide-based ion conductor 14b (LLNOF) in the positive electrode layer 14. Moreover, Example 9 and Comparative example 1 have similar battery configurations except for the presence or absence of the oxide-based ion conductor 14b (LATP) in the positive electrode layer 14.

In Comparative example 1, the initial resistance of the secondary battery 10 is 100%, whereas in Example 1, the initial resistance of the secondary battery 10 is reduced to 81%. Furthermore, the durability of the secondary battery 10 in Comparative example 1 is 90.4%, whereas the durability of the secondary battery 10 in Example 1 is improved to 94%.

In Comparative example 2, the initial resistance of the secondary battery 10 is 105%, whereas in Example 2, the initial resistance of the secondary battery 10 is reduced to 84%. In Comparative example 2, the durability of the secondary battery 10 was 93%, whereas in Example 2, the durability of the secondary battery 10 was improved to 97%.

In Comparative example 3, the initial resistance of the secondary battery 10 was 98%, whereas in Example 3, the initial resistance of the secondary battery 10 was reduced to 78%. In Comparative example 3, the durability of the secondary battery 10 was 88%, whereas in Example 3, the durability of the secondary battery 10 was improved to 92.5%.

In Comparative example 4, the initial resistance of the secondary battery 10 was 120%, whereas in Example 8, the initial resistance of the secondary battery 10 was reduced to 105%. In Comparative example 4, the durability of the secondary battery 10 was 88%, whereas in Example 4, the durability of the secondary battery 10 was improved to 90%.

In Comparative example 1, the initial resistance of the secondary battery 10 is 100%, whereas in Example 9, the initial resistance of the secondary battery 10 is reduced to 98%. Furthermore, the durability of the secondary battery 10 in Comparative example 1 was 90.4%, whereas the durability of the secondary battery 10 in Example 9 was improved to 91.6%.

From Example 1 and Comparative example 1, Example 2 and Comparative example 2, Example 3 and Comparative example 3, Example 8 and Comparative example 4, and Example 9 and Comparative example 1, it can be seen that by providing the oxide-based ion conductor 14b, which is a high dielectric, in the positive electrode layer 14, the initial resistance of the secondary battery 10 can be reduced and its durability can be improved. In Example 9, LATP having a relative dielectric constant of 93 is used as the oxide-based ion conductor 14b, and it has been confirmed that if the relative dielectric constant of the oxide-based ion conductor 14b is 93 or more, it is possible to suppress a decrease in the output of the secondary battery 10 while suppressing deterioration of the secondary battery 10. Considering the measurement error of the relative dielectric constant, it is believed that using the oxide-based ion conductor 14b having a relative dielectric constant of 90 or more can have the effect of suppressing deterioration of the secondary battery 10 and improving its durability.

In Example 8, the ratio A/B of the electrode opposing area A to the battery capacity B is 10, and the durability of the secondary battery 10 is improved compared to Comparative example 4 in which A/B is 10. In Examples 4 and 5, the ratio A/B of the electrode opposing area A to the battery capacity B is 30 to 35, and the durability of the secondary battery 10 is improved compared to Comparative example 1 in which A/B is 42. In other words, if the ratio A/B of the electrode opposing area A to the battery capacity B is 10 or more, the effect of improving the durability of the secondary battery 10 can be reliably obtained, and if A/B is 30 or more, it is thought that an even greater effect of improving the durability of the secondary battery 10 can be obtained.

In Examples 6 and 7, the electrode opposing area A and the battery capacity B are different from those in Example 1, but the ratio A/B of the electrode opposing area A to the battery capacity B is the same as in Example 1. In Examples 6 and 7, the durability of the secondary battery 10 is 94%, the same as in Example 1. That is, by providing the oxide-based ion conductor 14b, which is a high dielectric constant, in the positive electrode layer 14, the durability of the secondary battery 10 can be improved regardless of the battery size.

According to the present embodiment, in the secondary battery 10 in which the electrolyte solution 15a contains LiPF₆, which is a fluorine-containing lithium salt, the positive electrode layer 14 is provided with the positive electrode active material 14a and the oxide-based ion conductor 14b. The oxide-based ion conductor 14b is a dielectric material that has lithium ion conductivity and can promote dissociation of lithium ions from the fluorine-containing lithium salt. Due to the dielectric effect of the oxide-based ion conductor 14b, the reaction of dissociating lithium ions from LiPF₆ occurs preferentially, and LiPF₆ can be reduced. As a result, the reaction of dissociating PF₅ from LiPF₆ becomes less likely to occur, and the generation of hydrogen fluoride can be suppressed. As a result, it is possible to suppress a decrease in the resistance of the secondary battery 10, and also to suppress deterioration of the secondary battery 10 caused by the generation of hydrogen fluoride from the fluorine-containing lithium salt.

In this embodiment, by using the oxide-based ion conductor 14b (LLNOF, LATP) having a relative dielectric constant of 90 or more, the generation of hydrogen fluoride can be suppressed, thereby enhancing the effect of suppressing deterioration of the secondary battery 10. Furthermore, by using the oxide-based ion conductor 14b (LLNOF) having a relative dielectric constant of 200 or more, the generation of hydrogen fluoride can be suppressed, and the effect of suppressing deterioration of the secondary battery 10 can be further enhanced.

Furthermore, in high-power batteries, the larger the reaction area, the greater the impact of hydrogen fluoride on the deterioration of the secondary battery 10, and providing the oxide-based ion conductor 14b is more effective in suppressing the deterioration of the secondary battery 10 and improving its durability. Therefore, in a high-power secondary battery 10 in which the ratio A/B of the electrode opposing area A (mm) to the battery capacity B (mAh) is 10 (mm/mAh) or more, by providing the oxide-based ion conductor 14b, which has a high dielectric constant, in the positive electrode layer 14, the durability of the secondary battery 10 can be effectively improved.

Furthermore, by providing the oxide-based ion conductor 14b in the positive electrode layer 14 of the secondary battery 10 having an A/B ratio of 30 (mm²/mAh) or more, the durability of the secondary battery 10 can be improved more effectively, and by providing the oxide-based ion conductor 14b in the positive electrode layer 14 of the secondary battery 10 having an A/B ratio of 40 (mm²/mAh) or more, the durability of the secondary battery 10 can be improved even more effectively.

In this embodiment, the oxide-based ion conductor 14b is a pyrochlore-type oxide, which is an oxyfluoride having a defect structure such as LLNOF. Such pyrochlore-type oxides have high ionic conductivity. By using an oxide having high ionic conductivity for the positive electrode layer 14, the resistance of the positive electrode can be reduced, and the output of the secondary battery 10 can be improved.

In this embodiment, LiPF₆ is used as the electrolyte of the electrolyte solution 15a. Since LiPF₆ easily generates hydrogen fluoride, the effect of suppressing the generation of hydrogen fluoride can be enhanced when the positive electrode layer 14 is provided with the oxide-based ion conductor 14b, which has a high dielectric constant.

In this embodiment, the positive electrode active material 14a contains Mn in its composition. Since Mn contained in the positive electrode active material 14a is easily dissolved by hydrogen fluoride, the effect of suppressing deterioration of the secondary battery 10 is enhanced when a high-dielectric oxide-based ion conductor 14b is provided in the positive electrode layer 14 of a secondary battery 10 using the positive electrode active material 14a containing Mn in its composition.

In this embodiment, LMFP containing a higher Mn content than Fe is used as the positive electrode active material 14a. Therefore, when the positive electrode layer 14 is provided with the oxide-based ion conductor 14b, which has a high dielectric constant, the effect of suppressing deterioration of the secondary battery 10 is enhanced.

In this embodiment, the particle diameter of the oxide-based ion conductor 14b is smaller than the particle diameter of the positive electrode active material 14a. This increases the specific surface area of the oxide-based ion conductor 14b, thereby enhancing the dielectric effect and increasing the effect of promoting dissociation of lithium ions from the fluorine-containing lithium salt by the oxide-based ion conductor 14b.

In this embodiment, the negative electrode active material contains a silicon-based negative electrode material. Silicon-based negative electrode materials have a high water adsorption capacity and tend to generate hydrogen fluoride from fluorine-containing lithium salts. Therefore, in a secondary battery 10 in which the negative electrode active material contains a silicon-based negative electrode material, it is possible to effectively suppress the generation of hydrogen fluoride from a fluorine-containing lithium salt by providing a high-dielectric oxide-based ion conductor 14b in the positive electrode layer 14.

The present disclosure is not limited to the above-described embodiments and can be variously modified as follows without departing from the spirit of the disclosure. The means disclosed in the above-described embodiments may be appropriately combined to the extent practicable.

For example, the shape of the secondary battery 10 is not limited to the shapes described in the above embodiment, and various shapes such as a cylindrical shape, a square shape, a pouch shape (laminate shape) and the like can be used.

The secondary battery 10 described in the embodiments may be configured as a bipolar battery. A bipolar battery has a structure in which plural battery cells are stacked and connected in series, with adjacent battery cells sharing a current collector. In other words, the current collector in contact with the positive electrode of one adjacent battery cell is in contact with the negative electrode of the other adjacent battery cell. When a bipolar battery is used as a high-power battery, the deterioration caused by the generation of hydrogen fluoride is significant. Therefore, in the secondary battery 10 configured as a bipolar battery, by providing the oxide-based ion conductor 14b, which has a high dielectric constant, in the positive electrode layer 14, deterioration due to the generation of hydrogen fluoride can be effectively suppressed.

The secondary battery 10 described in the embodiment may be configured as an anode-free battery. In an anode-free battery, in the initial state, the negative electrode layer 12 is not formed on the negative electrode current collector 11, and lithium ions migrate from the positive electrode layer 14 upon charging, causing lithium metal to be deposited on the negative electrode current collector 11, forming the negative electrode layer 12. The lithium metal of the negative electrode layer 12 moves to the positive electrode layer 14 as lithium ions during discharge. When an anode-free battery is used, the area of the opposing surfaces of the electrodes depends on the area of the positive electrode layer 14 because the negative electrode layer 12 is not formed in the initial state.

Although the present disclosure has been described in accordance with embodiments, it is understood that the present disclosure is not limited to the embodiments and the structures. The present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A secondary battery comprising:
a positive electrode layer;
a negative electrode layer; and
an electrolyte layer to conduct lithium ion between the positive electrode layer and the negative electrode layer, wherein
the positive electrode layer has a positive electrode active material containing Mn in its composition and an oxide-based ion conductor having lithium ion conductivity,
the electrolyte layer has a fluorine-containing lithium salt containing fluorine atoms, and a solvent to dissolve the fluorine-containing lithium salt,
the oxide-based ion conductor is a dielectric material capable of facilitating dissociation of lithium ion from the fluorine-containing lithium salt, and
the oxide-based ion conductor contains an oxyfluoride.

2. The secondary battery according to claim 1, wherein the oxide-based ion conductor has a relative dielectric constant of 90 or more.

3. The secondary battery according to claim 1, wherein the oxyfluoride has a pyrochlore-type crystal structure and a defect structure.

4. The secondary battery according to claim 1, wherein a ratio A/B is 30 (mm²/mAh) or more, in which
A represents an electrode opposing area (mm²) of an opposing surface in which the positive electrode layer and the negative electrode layer oppose to each other, and
B represents a battery capacity (mAh).

5. The secondary battery according to claim 1, wherein the positive electrode active material contains LiMn₁₋ₓFeₓPO₄ (where 0<x<1).

6. The secondary battery according to claim 5, wherein x in the LiMn₁₋ₓFeₓPO₄ is 0.5 or less.

7. The secondary battery according to claim 1, wherein a particle diameter of the oxide-based ion conductor is smaller than a particle diameter of the positive electrode active material.

8. The secondary battery according to claim 1, wherein
the negative electrode layer includes a negative electrode active material, and
the negative electrode active material contains a silicon-based negative electrode material containing Si.

9. The secondary battery according to claim 1, wherein the positive electrode layer is a random mixture of particles of the positive electrode active material and particles of the oxide-based ion conductor.

10. The secondary battery according to claim 1, wherein an outer surface of the positive electrode active material in particulate state is coated with the oxide-based ion conductor, in the positive electrode layer.

11. The secondary battery according to claim 1, wherein a proportion x of the oxide-based ion conductor added to the positive electrode active material is 0 wt %<x≤10 wt %.

12. The secondary battery according to claim 1, wherein the electrolyte layer has an electrolyte solution to dissolve a fluorine-containing lithium salt containing LiPF₆.
